(19) United States
(12) Patent Application Publication
(10) Pub. No.: US 2006/0125320 A1
(43) Pub. Date: Jun. 15, 2006

(54) Lighting control circuit for vehicle lighting device

(76) Inventors: Takanori Namba, Shizuoka (JP); Masayasu Ito, Shizuoka (JP)

Correspondence Address: FISH & RICHARDSON P.C., P.O. BOX 1022, MINNEAPOLIS, MN, 55440-1022, US

(21) Appl. No.: 11/282,246

(22) Filed: Nov. 18, 2005

(30) Foreign Application Priority Data
Nov. 19, 2004 (JP) P.2004-336101

(51) Int. Cl. H02G 3/00

(52) U.S. Cl. 307/10.1

(57) ABSTRACT

An ON/OFF-operation of a main switch SW and auxiliary switches SW1 to SW5 is controlled by a microcomputer 28. Electromagnetic energy in a transformer T is accumulated in an ON operation of the main switch SW and discharged in the transformer T sequentially to output blocks 14 to 22 on the secondary side in an OFF operation of the main switch SW. The electromagnetic energy is discharged twice separately to the output blocks 14, 18 connected to semiconductor light sources A, C having a heavy load, respectively, in one control period T, whereas the electromagnetic energy is discharged only once to the output blocks 16, 20, 22 connected to remaining semiconductor light sources B, D, E, respectively. Therefore, the peak value of the primary current I1 flowing through the primary winding L of the transformer T can be reduced.

### TECHNICAL FIELD

The present disclosure relates to a lighting control circuit for a vehicle lighting device and, more particularly, to a lighting control circuit for a vehicle lighting device constructed to control the lighting state of a semiconductor light source composed of a semiconductor light emitting element.

### BACKGROUND ART

An LED (Light Emitting Diode) is an example of a semiconductor light source that has been used in vehicle lighting devices. A lighting control circuit to control the lighting state of the LED is installed into the vehicle lighting device of this type.

The lighting control circuit may include a switching regulator that includes a switching element and a transformer, and also an output block that includes a rectifier diode and a smoothing capacitor to operate such that an input voltage: fed from a DC power supply is accumulated in the transformer as an electromagnetic energy when the switching element is turned ON. The electromagnetic energy accumulated in the transformer is discharged from the secondary side of the transformer to the output block when the switching element is turned OFF, and the electromagnetic energy is supplied from the output block to the LED as a luminous energy. In this case, when multiple loads composed of LEDs are provided as the objective load, multiple output blocks may be provided to the secondary side of the transformer such that the luminous energy is supplied to respective loads sequentially via the output blocks (see, e.g., Japanese patent document JP-A-2004-134146 (particularly page 3 to page 6, and FIG. 1).

As shown, for example, in FIG. 10, upon supplying the luminous energy sequentially to the five loads (i.e., semiconductor light sources A, B, C, D, E), an ON/OFF operation of a mainswitch (switching element) SW of the switching regulator is controlled in response to the extent of power consumption in respective loads. Also auxiliary switches (switching elements) SW1 to SW5, which are provided to the respective output blocks to open/close an energy propagation circuit, are turned ON sequentially. In this case, a primary current I1 flows through the primary side of the transformer when the main switch SW of the switching regulator is turned ON, while a secondary current I2 flows through the secondary side of the transformer when the main switch SW is turned OFF. Then, the electromagnetic energy generated by this secondary current I2 is supplied to the LED as the load via either output block (i.e., the output block whose auxiliary switch is in its ON state).

This propagation of energy (the supply of energy) is carried out only when any one of the auxiliary switches SW1 to SW5 is kept in its ON state. The auxiliary switch to be turned ON is switched sequentially every time when the main switch SW is turned ON. The auxiliary switch, which serves as the propagation object of the electromagnetic energy, switches from its OFF state to its ON when the electromagnetic energy accumulated on the primary side of the transformer has been discharged completely to the secondary side of the transformer (i.e., when the secondary current I2 has become zero), so that the main switch SW and respective auxiliary switches SW1 to SW5 can be operated in a current boundary mode. When the main switch SW and the auxiliary switches SW1 to SW5 are caused to operate in the current boundary mode, the electromagnetic energy accumulated on the primary side of the transformer can be supplied completely in seriatim to respective loads. Thus, the power necessary for each load can be supplied by controlling the ON operation and the OFF operation of the main switch of the switching regulator in response to the extent of the power consumption of the load (i.e., semiconductor light source).

In some situations, when supplying the power (luminous energy) to a multiple loads sequentially, the power is supplied to each load only once in each control period. Therefore, as shown in FIG. 10, when the power should be supplied to the loads (A, C) whose power consumption is high, an ON-time of the main switch SW of the switching regulator must be set longer than the case where the power is supplied to other loads (B, D, E) whose power consumption is lower than the loads A, C. Thus, a peak value of the primary current I1 is increased correspondingly. The peak value of the primary current I1 is increased as the power consumption of the load is increased. Even if the vehicle lighting device is designed in view of the fact that the peak value of the primary current I1 is increased, respective capacities of the main switch SW (switching element) of the switching regulator and the transformer must be increased, which results in an increase in size and an increase in cost of the lighting control circuit.

### SUMMARY

The present invention has been made in light of the above problem and, in some implementations, the present invention may reduce a peak value of a primary current that flows through the primary side of a transformer of a switching regulator.

According to an aspect of the invention, a lighting control circuit for a vehicle lighting device includes a switching regulator for accumulating an input voltage as electromagnetic energy in a transformer in an ON operation of a main switch, and discharging the electromagnetic energy accumulated in the transformer from a secondary side of the transformer in an OFF operation of the main switch. Output blocks are located between loads, each of which is composed of a semiconductor light source, and the secondary side of the transformer; for propagating the electromagnetic energy, discharged from the secondary side of the transformer to respective loads. The lighting control circuit includes a controlling means for classifying a group of output blocks as objects of propagation of the electromagnetic energy into “particular” output blocks (each of which is designated multiple times as the object of propagation of the electromagnetic energy) and “remaining” output blocks every control period in which the electromagnetic energy is propagated sequentially through the loads, to correlate with the propagation order of the electromagnetic energy. The controlling means also is for controlling an ON/OFF operation of the main switch in response to a level of the load of the designated output block. Each output block includes a rectifying element for rectifying a current output from the secondary side of the transformer, a capacitor for smoothing an output current of the rectifying element, and an auxiliary switch for opening/closing a circuit that connects the secondary side of the transformer and each load. The controlling means ON/OFF operates the auxiliary switch of the designated output block sequentially in compliance with a propagation order of the electromagnetic energy, under the condition that only a single auxiliary switch for the output blocks is turned ON in each control period in an OFF operation of the main switch.

In supplying the power from the switching regulator to respective loads via respective output blocks in accordance with the electromagnetic energy; the ON-operation time of the main switch of the switching regulator can be shortened compared to the case where the electromagnetic energy is discharged only once in one control period, because the power is supplied multiple times separately to the load connected to the particular output block every control period. Therefore, the peak value of the primary current flowing through the primary side of the transformer can be reduced. Also, the main switch and the transformer can have a small capacity. As a result, the present invention can contribute to a reduction in size and a reduction in cost of the main switch SW and the transformer.

According to another aspect, the controlling means increases or decreases the number of output blocks to be designated as a group of output blocks as the object of the propagation of the electromagnetic energy compared to the number in a preceding control period.

Since the number of the output blocks to be designated as a group of output blocks as the object of the propagation of the electromagnetic energy can be increased or decreased compared to that in the preceding control period depending upon the control period, the number of times power is supplied to the heavy load can be increased, or the number of times power is supplied to the light load can be reduced. Therefore, the supply of power to the load that is not always required to emit light, or the light load (i.e., the load having small power consumption), can be reduced, and the number of times power is supplied to the heavy load can be increased correspondingly. As a result, the peak value of the primary current required when the power is supplied to the heavy load can be reduced.

In a further aspect, the controlling means classifies the output blocks into two groups based on a level of the load, and then designates output blocks belonging to a heavy load group as “particular” output blocks and also designates output blocks belonging to a light load group (except the particular output blocks) as “remaining” output blocks.

The output blocks belonging to the heavy load group are designated as “particular” output blocks and the output blocks belonging to the light load group (except the particular output blocks) are designated as “remaining” output blocks. Therefore, when the power is supplied separately multiple times to the particular output block belonging to the heavy load group (i.e., the load having the large power consumption), the peak value of the primary current of the transformer can be reduced.

Various advantages may be present in some implementations. For example, use of a main switch and transformer having a small capacity can contribute to a size reduction and a cost reduction of the device.

Similarly, the peak value of the primary current required when the power is supplied to the heavy load can be reduced.

Furthermore, since the power is supplied separately multiple times to the particular output block belonging to the heavy load group, the peak value of the primary current of the transformer can be reduced.

Other features and advantages may be apparent from the following detailed description, the accompanying drawings and the claims.

### BRIEF DESCRIPTION OF THE DRAWINGS

FIG. 1 is a block circuit diagram of a lighting control circuit for a vehicle lighting device showing an embodiment of the present invention.

FIG. 2 is a waveform diagram explaining an operation of the lighting control circuit shown in FIG. 1.

FIG. 3 is a circuit diagram of a main switch of a switching regulator.

FIG. 4 is a circuit diagram of an auxiliary switch of an output block.

FIG. 5 is a circuit diagram of a secondary-side operation sensing circuit and an ON-timing discriminating circuit.

FIG. 6 is a waveform diagram of waveforms at respective portions of the circuits shown in FIG. 5 in a current boundary mode.

FIG. 7 is a waveform diagram of waveforms at respective portions of the circuits shown in FIG. 5 in a current discontinuous mode.

FIG. 8 is a waveform diagram of waveforms at respective portions of the circuits shown in FIG. 5 in a current continuous

FIG. 9 is a flowchart explaining an operation of the circuits shown in FIG. 5.

FIG. 10 is a waveform diagram explaining an operation of a multi-output type switching regulator according to a known technique.

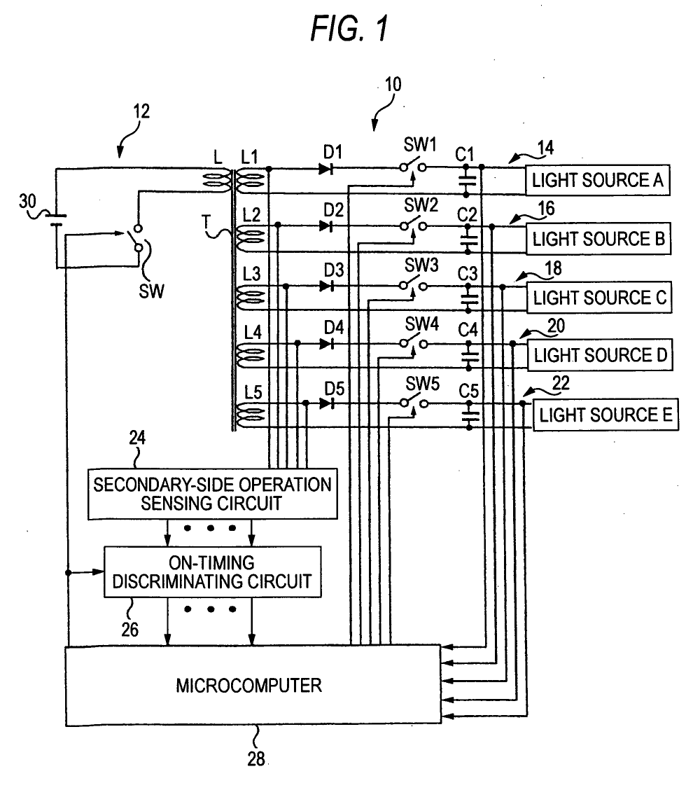

### DETAILED DESCRIPTION AND BEST MODE FOR CARRYING OUT THE INVENTION

Below, an implementation of the present invention is explained.

As illustrated in the figures, a lighting control circuit 10 for a vehicle lighting device includes a multi-output type switching regulator 12, output blocks 14, 16, 18, 20, 22, a secondary-side operation sensing circuit 24, an ON-timing discriminating circuit 26, and a microcomputer 28 (referred to as a “micro” hereinafter) as an element of the vehicle lighting device (light emitting device) respectively to energize five semiconductor light sources A, B, C, D, E. The semiconductor light sources A to E may comprise LEDs, for example, as the semiconductor light emitting elements.

A single LED can be employed as the light emitting element. Alternatively, two or more series-connected LEDs may be employed. In other implementations, parallel-connected light source blocks, each of which may be constructed by connecting LEDs in series, may be employed. Also, respective semiconductor light sources A to E can be employed as the light source of various vehicle lighting devices such as a head lamp, a stop & tail lamp, a fog lamp, a turn signal lamp, and the like.

As illustrated, the switching regulator 12 has a main switch SW and a transformer T. One end side of a primary winding L of the transformer T is connected to a plus terminal of an onboard battery (DC power supply) 30 and the other end side thereof is connected to a minus terminal of the onboard battery 30 via the main switch SW. Both end sides of secondary windings L1, L2, L3, L4, L5 are connected to the output blocks 14, 16, 18, 20, 22 respectively. The main switch SW is ON/OFF-operated in response to a switching signal from the micro 28. The transformer is designed such that an input voltage fed from the onboard battery 30 is accumulated in the primary winding L as the electromagnetic energy when the main switch SW is turned ON. The electromagnetic energy accumulated in the primary winding L is output to any one of output blocks 14 to 22 from the secondary side when the main switch SW is turned OFF.

Output blocks 14, 16, 18, 20, 22 are connected to the semiconductor light sources A, B, C, D, E as the loads, respectively. In order to propagate the electromagnetic energy discharged from the secondary side of the transformer to the semiconductor light sources A to E, the output blocks 14, 16, 18, 20, 22 may include diodes D1, D2, D3, D4, D5 as rectifying devices for rectifying the current output from the secondary side of the transformer, capacitors C1, C2, C3, C4, C5 for smoothing output currents of the diodes D1 to D5, and auxiliary switches SW1, SW2, SW3, SW4, SW5 for opening/closing the circuits that connect the secondary side of the transformer and the loads, respectively. The auxiliary switches SW1 to SW5 are ON/OFF-operated in response to the switching signal from the micro 28 respectively.

The micro 28 serves as a controlling means that receives a sensed output of the secondary-side operation sensing circuit 24, an inspected output of the ON-timing discriminating circuit 26 and output voltages of the output blocks 14, 16, 18, 20, 22. The micro 28 then executes various calculations, and controls the ON/OFF operation of the main switch SW and the auxiliary switches SW1 to SW5 in accordance with the calculated results.

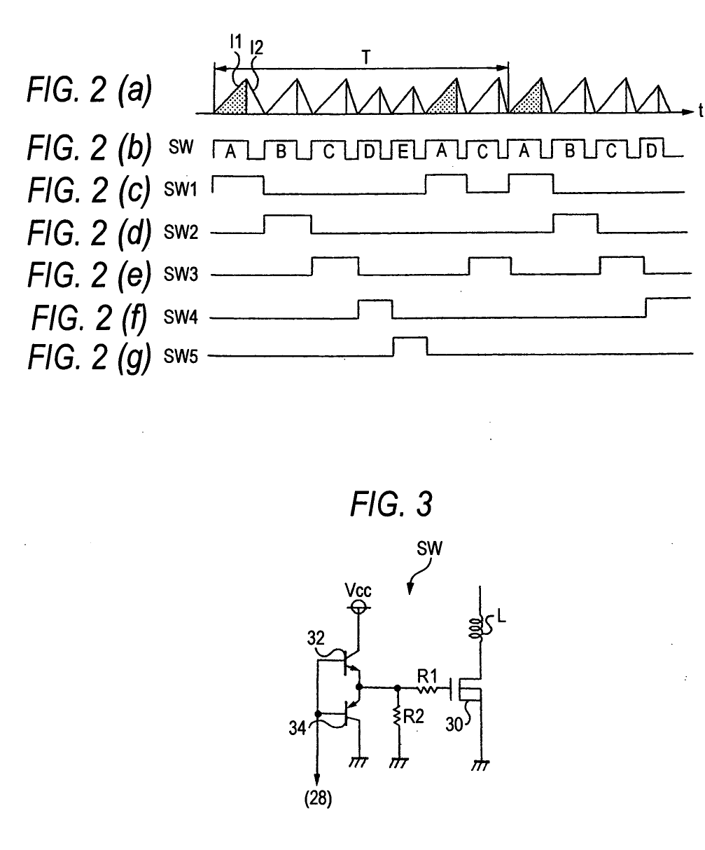

In particular, as shown in FIG. 2, for example, the micro 28 sets a control period T to correspond to a period within which the lighting state of the respective semiconductor light sources A to E can be maintained even when the electromagnetic energy discharged from the transformer is propagated sequentially through the semiconductor light sources A to E. Then, the micro 28 classifies a group of output blocks 14 to 22 as the objects of propagation of the electromagnetic energy into “particular” output blocks (each being designated multiple times as the object of propagation of the electromagnetic energy) and “remaining” output blocks (each being designated only once as the object of propagation of the electromagnetic energy) every control period T, in which the electromagnetic energy is propagated sequentially through the semiconductor light sources A to E, to correlate with the propagation order of the electromagnetic energy. Then, the micro 28 controls the ON/OFF operation (ON/OFF time) of the main switch SW in response to the level of the load of the designated output block (i.e., the extent of the power consumption in the semiconductor light sources A to E), and also causes the auxiliary switches SW1 through SW5 to execute the ON/OFF operation sequentially in response to the propagation order of the electromagnetic energy.

In classifying the output blocks 14 to 22 into the “particular” output blocks and “remaining” output blocks, the output blocks 14 to 22 are classified into two groups based on the level of the load (the magnitude of the load). Then the output blocks belonging to the heavy load (large load) group are designated as the “particular” output blocks and also the output blocks belonging to the light load (small load) group (except the particular output blocks) are designated as the “remaining” output blocks.

For instance, in the case where the semiconductor light sources. A, C, whose power consumption is larger than those of other semiconductor light sources B, D, E, constitute the heavy load, the output blocks 14, 18 are designated as the “particular” output blocks, and output blocks 16, 20, 22 are designated as the “remaining” output blocks (except the “particular” output blocks). Then, if the electromagnetic energy is discharged twice to the particular output blocks 14, 18 in one control period T, the first place, the second place, the third place, the fourth place, and the fifth place are allocated, respectively to the output block 14, the output block 16, the output block 18, the output block 20, and the output block 22 as the propagation order of the electromagnetic energy. The sixth place and the seventh place would be allocated to the output block 14 and the output block 18, respectively. Then, in order to execute the accumulation and discharge of the electromagnetic energy seven times in one control period T, as shown in FIGS. 2 (a), (b), the micro 28 controls the ON/OFF operation of the main switch SW sequentially in accordance with the level of the load of the output blocks 14 to 22. When the main switch SW is turned ON, the primary current I1 flows through the primary winding L and the electromagnetic energy is accumulated in the primary winding L. When the main switch SW is turned OFF, the electromagnetic energy accumulated in the primary winding L is discharged to the secondary side of the transformer T, the secondary current 12 flows through the secondary side (the secondary winding) of the transformer T and the electromagnetic energy is discharged from the secondary side of the transformer T.

In this case, in order to control the ON/OFF operation of the main switch SW and the auxiliary switches SW1 to SW5 in a current boundary mode, the micro 28 causes the auxiliary switches SW1 to SW5 to execute the ON/OFF operation sequentially in each control period T based on the propagation order of the electromagnetic energy, under the condition that only a single auxiliary switch out of the auxiliary switches SW1 to SW5 of the output blocks 14 to 22 is turned ON during the OFF operation of the main switch SW.

More specifically when the main switch SW is turned ON sequentially, the auxiliary switches SW1 to SW5 are turned ON in synchronism with the ON timing of the main switch SW in order of the auxiliary switches SW1, SW2, SW3, SW4, SW5, SW1 and SW3. Also, when the main switch SW is shifted from its OFF state to its ON state, (i.e., when the electromagnetic energy accumulated in the primary side of the transformer T is discharged completely to the secondary side and the secondary current I2 is reduced to 0), the auxiliary switch that is in its ON state is shifted to its OFF state in synchronism with the shift timing of the main switch SW.

In this manner, since the electromagnetic energy is discharged twice in one control period T separately to the output blocks 14, 18, which are connected to the heavy load, the peak value of the primary current I1 can be reduced and the capacity of the main switch SW and the transformer T can be reduced compared to the case where the electromagnetic energy is discharged only once in one control period T. Thus, the present embodiment can contribute to a reduction in size and a reduction in cost of the main switch SW and the transformer T.

As described above, the electromagnetic energy is discharged twice to the output blocks 14, 18 connected to the semiconductor light sources A, C, which bear the heavy load, respectively, in one control period T. In other cases, the electromagnetic energy can be discharged three times or more in one control period T. Also, the propagation order (discharge order) of the electromagnetic energy through the output blocks 14 to 22 can be set arbitrarily under the condition that the lighting state of the semiconductor light sources A to E can be maintained.

Also, depending on the control period T, the number of the output blocks to be designated as a group of output blocks as the object of the propagation of the electromagnetic energy can be increased or decreased compared to that in the preceding control period T. For example, the number of times the electromagnetic energy is propagated through (discharged to) the semiconductor light source having the small power consumption can be lowered, and then the number of times the electromagnetic energy is propagated through (discharged to) the semiconductor light source having the large power consumption can be increased correspondingly. In this case, because the number of times of the propagation (discharge) of the electromagnetic energy (the number of times of the supply of the power) to the semiconductor light source having the large power consumption (the heavy load) is increased, the peak value of the primary current required when the power is supplied to the semiconductor light source having the large power consumption can be reduced.

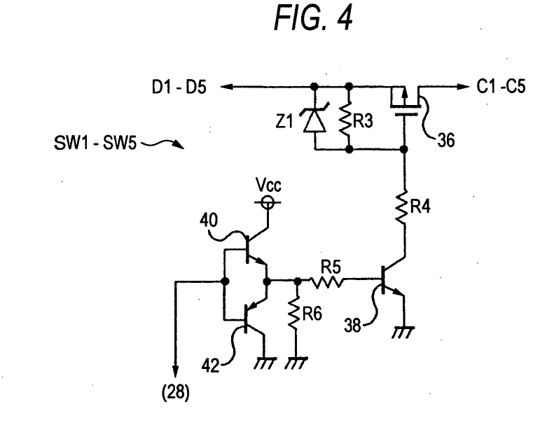

Next, specific examples of configurations of the main switch SW and the auxiliary switches SW1 to SW5 will be explained with reference to FIG. 3 and FIG. 4.

As shown in FIG. 3, the main switch SW includes an NMOS transistor 30 acting as a switching element, resistors R1, R2, an NPN transistor 32, and a PNP transistor 34. A drain of the NMOS transistor 30 is connected to the primary winding L of the transformer T, and a source thereof is grounded. Both bases of the NPN transistor 32 and the PNP transistor 34 are connected to the micro 28 respectively. The NPN transistor 32 and the PNP transistor 34 constitute a buffer circuit. When the switching signal at a high level is provided as an output from the micro 28, the NPN transistor 32 is turned ON and also the NMOS transistor 30 is turned ON, so that the electromagnetic energy is accumulated in the primary winding L. In contrast, when the switching signal at a low level is provided as an output from the micro 28, the PNP transistor 34 is turned ON and also the NMOS transistor 30 is turned OFF. As a result, the electromagnetic energy accumulated in the primary winding L is discharged to the secondary side of the transformer T.

As shown in FIG. 4, each of the auxiliary switches SW1 to SW5 includes a PMOS transistor 36 acting as the switching element, a Zener diode Z1, resistors R3, R4, R5, R6, NPN transistors 38, 40, and a PNP transistor 42. A source of the PMOS transistor 36 is connected to a cathode of the diodes D1 to D5, and a drain thereof is connected to the capacitors C1 to C5. Both bases of the NPN transistor 40 and the PNP transistor 42 are connected to the micro 28 respectively. The NPN transistor 40 and the PNP transistor 42 constitute a buffer circuit. When the switching signal at a high level is provided as an output from the micro 28, the NPN transistor 40 is turned ON and also the NPN transistor 38 is turned ON. Then, subsequent to the turning ON of the NPN transistor 38, the PMOS transistor 36 is turned ON. As a result, the signals rectified by the diodes D1 to D5 are transmitted to the capacitors C1 to C5 side, and thus the electromagnetic energy discharged from the secondary side of the transformer T is carried to the designated semiconductor light source.

In contrast, when the switching signal at a low level is provided as an output from the micro 28, the PNP transistor 42 is turned ON and the NPN transistor 38 is turned OFF. Then, subsequent to the turning OFF of the NPN transistor 38, the PMOS transistor 36 is turned OFF. As a result, the propagation of the electromagnetic energy is shut off.

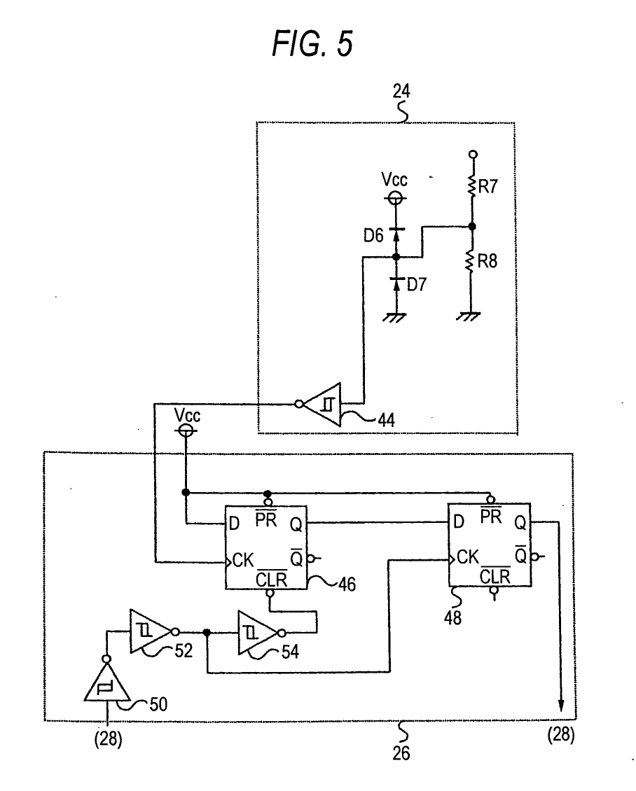

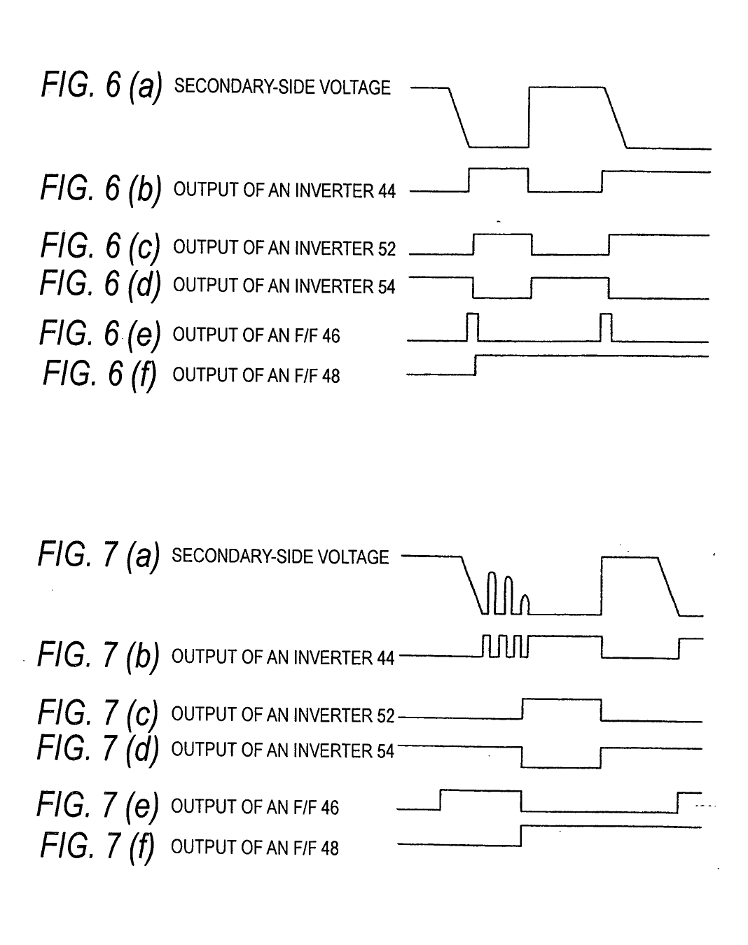

Next, specific examples of configurations of the secondary-side operation sensing circuit and the ON-timing discriminating circuit will be explained with reference to FIG. 5. The secondary-side operation sensing circuit 24 corresponds to respective output blocks 14 to 22. As a means for sensing whether or not the electromagnetic energy is being discharged from the secondary side of the transformer T, the secondary-side operation sensing circuit 24 includes resistors R7, R8, diodes D6, D7, and a Schmitt trigger inverter 44. One end side of the resistor R7 is connected to one end side of the secondary windings L1 to L5. An output side of the Schmitt trigger inverter 44 is connected to the ON-timing discriminating circuit 26. The resistors R7, R8 serve as a voltage dividing means for diving a voltage on the secondary side of the transform T, and a divided voltage is clamped by the diodes D6, D7. The voltage clamped by the diodes D6, D7 is compared with a reference value by the Schmitt trigger inverter 44. A signal is provided as an output from the Schmitt trigger inverter 44 based on the compared result. The Schmitt trigger inverter 44 compares the input voltage with a reference value (0 V) Then, as shown in FIG. 6 (a), (b), the Schmitt trigger inverter 44 provides an output signal at a low level when the main switch SW is turned OFF and the secondary-side voltage becomes higher than 0 V following upon the discharge of the electromagnetic energy, and provides an output signal at a high level when the secondary-side voltage goes to 0 V and the main switch SW is turned ON.

The ON-timing discriminating circuit 26 corresponds to respective output blocks 14 to 22. To discriminate whether a timing at which the main switch SW is turned ON should be set to a point of time during the discharge or after the discharge of the electromagnetic energy, the ON-timing discriminating circuit 26 includes D-type flip-flops 46, 48, and Schmitt trigger inverters 50, 52, 54. A clock terminal CK of the flip-flop 46 is connected to the Schmitt trigger inverter 44, and an output terminal Q thereof is connected to an input terminal D of the flip-flop 48. An output terminal Q of the flip-flop 48 is connected to the micro 28. An input side of the Schmitt trigger inverter 50 is connected to the micro 28, and an output side thereof is connected to the Schmitt trigger inverter 52. An output side of the Schmitt trigger inverter 52 is connected to the Schmitt trigger inverter 54, and is connected to a clock terminal of the D-type flip-flop 48. An output side of the Schmitt trigger inverter 54 is connected to a clear terminal CLR of the flip-flop 46.

The ON-timing discriminating circuit 26 receives the switching signal used to ON/OFF-operate the main switch SW at the Schmitt trigger inverter 50 from the micro 28, and also receives the low or high level signal from the Schmitt trigger inverter 44 in the secondary-side operation sensing circuit 24. Then, the ON-timing discriminating circuit 26 determines an operation mode based on the received signals to discriminate whether the timing at which the main switch SW is turned ON should be set to a point of time during the discharge or after the discharge of the electromagnetic energy, and then provides this decision result to the micro 28.

For example, when the main switch SW is in its OFF state and the switching signal used to cause the main switch SW to ON/OFF-operate is at a low level, a low level signal is provided as an input to the clock terminal CK of the flip-flop 48, as shown in FIG. 6 (c). Also, a high level signal is provided as an input into the clear terminal CLR of the flip-flop 46, as shown in FIG. 6 (d) Then a low level signal is provided as an output from the output terminal Q of the flip-flop 46.

Then, when a high level signal is provided as an input to the clock terminal CK of the flip-flop 46 immediately after the secondary-side voltage of the transformer T goes to 0, a high-level signal is provided as an output from the output terminal Q of the flip-flop 46. At this time, a level of the switching signal is changed to delay slightly. As soon as the level of the switching signal is shifted from the low level to the high level, the level of the clock terminal CK of the flip-flop 48 is changed from the low level to the high level, and then the high level signal is provided as an output as a mode decision signal to the micro 28 from the output terminal Q of the flip-flop 48. That is, the mode decision signal is provided as an output from the flip-flop 48 to the micro 28 at the timing at which the main switch SW is turned ON. This mode decision signal is held in the same state as far as the decision result is not changed.

The micro 28 receives the mode decision signal from the ON-timing discriminating circuit 26 and the output voltages of the output blocks 14 to 22. Then, the micro 28 sets an ON time (Ton) and an OFF time (Toff) based on the received signals to cause the main switch SW to ON/OFF-operate.

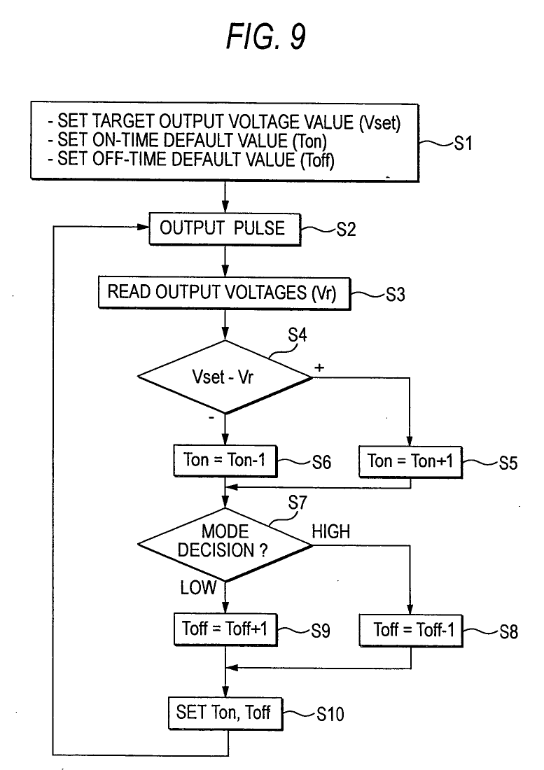

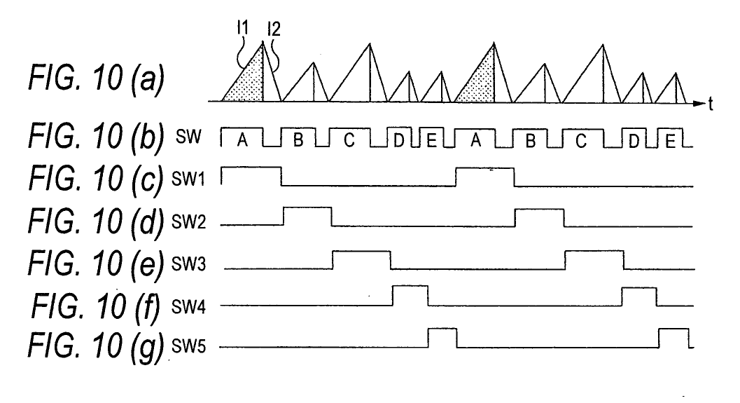

More specifically, as shown in FIG. 9, the micro 28 sets a target output voltage value Vset used to control the output voltages of the output blocks 14 to 22 constant, an ON-time (ON-time default value) Ton and an OFF-time (OFF-time default value) Toff used to ON/OFF operate the main switch SW (S1). Then, the micro 28 provides the switching signal generated based on this setting to the main switch SW (S2). Then, the micro 28 reads output voltages (Vr) of the output blocks 14 to 22 (S3), and compares the read output voltages Vr with the target output voltage value Vset (S4). If the value Vset is larger than the voltages Vr, the micro 28 decides that the output voltages Vr do not reach the target output voltage value and then increments the ON-time default value Ton by 1 (S5). In contrast, if the value Vset is smaller than the voltages Vr, the micro 28 decides that the output voltages are larger than the target output voltage value and then decrements the ON-time default value Ton by 1 (S6).

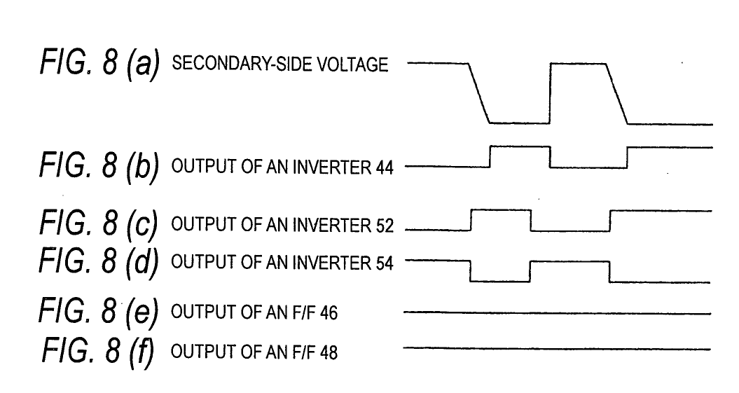

Next, the micro 28 decides whether or not the mode decision signal from the flip-flop 48 is at the high level (S7). Then, if the mode decision signal is at the high level, the micro 28 decides that the operation mode lies in a current discontinuous mode (see FIG. 7), and then decrements the OFF-time default value Toff by 1 (S8). That is, the micro 28 decides that the OFF time of the main switch SW is too long, and executes a process of shortening the OFF time of the main switch SW. In contrast, if the mode decision signal is at the low level, the micro 28 decides that the operation mode lies in a current continuous mode (see FIG. 8), and increments the OFF-time default value Toff by 1. That is, in order to extend the OFF time of the main switch SW, the micro 28 executes a process of adding a unit time (S9). Then, the micro 28 again sets the ON-time default value Ton and the OFF-time default value Toff according to the above process (10). The process returns to block S2.

When the mode decision signal is at the high level, the OFF time of the main switch SW is shortened gradually by executing repeatedly processes in blocks S2 to S10, and thus the operation mode comes closer to the current boundary mode. In this course, the level of the mode decision signal is reversed into the low level and, a process of extending the OFF time of the main switch SW is executed. In some cases the operation mode is returned to the current discontinuous mode again by this process. However, if the process executed in the current discontinuous mode and the process executed in the current continuous mode are repeated, the operation mode lies in the current boundary mode, as shown for example in FIG. 6, so that the main switch SW can be operated in the current boundary mode.

In this case, in order to control the ON/OFF operation of the main switch SW and the auxiliary switches SW1 to SW5 in the current boundary mode, the micro 28 provides the switching signal, which ON/OFF-operates the auxiliary switches sequentially in compliance with the propagation order of the electromagnetic energy, to the auxiliary switches SW1 to SW5, under the condition that only one auxiliary switch out of the auxiliary switches SW1 to SW5 for the output blocks 14 to 22 is turned ON in every control period T at the time of the OFF operation of the main switch SW.

Other implementations are within the scope of the claims.

What is claimed is:

1. A lighting control circuit for a vehicle lighting device comprising:
a switching regulator for accumulating an input voltage as an electromagnetic energy in a transformer in an ON operation of a main switch, and discharging the electromagnetic energy accumulated in the transformer from a secondary side of the transformer in an OFF operation of the main switch;
a plurality of output blocks located between a plurality of loads and the secondary side of the transformer, each load comprising a semiconductor light source, each block for propagating the electromagnetic energy discharged from the secondary side of the transformer to the respective loads; and
a controlling means for classifying a group of output blocks as objects of propagation of the electromagnetic energy into particular output blocks, each of which is designated multiple times as the object of propagation of the electromagnetic energy; and remaining output blocks every control period, in which the electromagnetic energy is propagated sequentially through the plurality of loads, to correlate with the propagation order of the electromagnetic energy, and controlling an ON/OFF operation of the main switch in response to the load of the designated output block;
wherein each output block includes a rectifying element for rectifying a current output from the secondary side of the transformer, a capacitor for smoothing an output current of the rectifying element, and an auxiliary switch for opening/closing a circuit that connects the secondary side of the transformer and each load, and
the controlling means ON/OFF-operates the auxiliary switch of the designated output block sequentially in compliance with a propagation order of the electromagnetic energy, under a condition that only a single auxiliary switch for the output blocks is turned ON in each control period in an OFF operation of the main switch.

2. A lighting control circuit for a vehicle lighting device, according to claim 1, wherein the controlling means is adapted to increase or decrease the number of output blocks to be designated as a group of output blocks as the object of the propagation of the electromagnetic energy compared to that in a preceding control period.

3. A lighting control circuit for a vehicle lighting device, according to claim 1, wherein the controlling means is adapted to classify the plurality of output blocks into two groups based on a level of the load, and to designate output blocks belonging to a heavy load group as particular output blocks and to designate output blocks belonging to a light load group, except the particular output blocks, as remaining output blocks.

4. A lighting control circuit for a vehicle lighting device, according to claim 2, wherein the controlling means is adapted to classify the plurality of output blocks into two groups based on a level of the load, and to designate output blocks belonging to a heavy load group as particular output blocks and to designate output blocks belonging to a light load group, except the particular output blocks, as remaining output blocks.
